(19) United States
(12) Patent Application Publication
(10) Pub. No.: US 2012/0006079 A1
(43) Pub. Date: Jan. 12, 2012

(54) Condo Smart Cart System

(75) Inventor: Marlena Corbo, Toronto (CA)

(73) Assignee: Marlena Corbo, King City (CA)

(21) Appl. No.: 13/016,918

(22) Filed: Jan. 28, 2011

Related U.S. Application Data
(60) Provisional application No. 61/299,333, filed on Jan. 28, 2010.

(51) Int. Cl. E05B 73/00

(52) U.S. Cl. 70/58

(57) ABSTRACT

Condo Smart Cart System is designed for consumers who desire a secure, convenient storing method for carts. Using a key or an identification card, this system will not allow any person besides the owner to access the cart. This product is ideal for storage in apartment or condo parking garages.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Condo Smart Cart System is designed for consumers who desire a secure, convenient storing method for carts. Using a key or an identification card, this system will not allow any person besides the owner security device. The security device can be mounted to a wall and may include a keyhole and a card slot. It can be made of suitable metal material. To lock the cart using either the key or card method, residents may insert the key provided at the end of the chain into the security device. To unlock the cart, each condo or apartment resident will have his/her own personalized key or card, which can be inserted into the device. The key or card may remain inside the device with visible unit number until the cart has been returned to the garage or parking area and locked into the device. This product may be available in a variety of colors to suit user preferences. The exact specifications may vary to access the cart. This product is ideal for storage in apartment or condo parking garages.

### BRIEF SUMMARY OF THE INVENTION

For residents of apartments or condos, transporting items such as groceries or heavy and large items from underground parking garages to their homes can be a laborious task. In these cases, a cart may be necessary. However, carts can be difficult to store. If they are left out, they can be easily stolen or misplaced. An efficient solution is necessary.

### BRIEF DESCRIPTION OF THE SEVERAL VIEWS OF THE DRAWING

FIG. 1—Shows the security device locked and the key

FIG. 2—Shows the security device unlocked and the key

FIG. 3—Shows the security device locked and the card

FIG. 4—Shows the security device unlocked and the card

FIG. 5—Shows the grocery cart locked to the security device

FIG. 6—Shows the grocery cart unlocked

FIG. 7—Shows the upright cart locked and folded

### DETAILED DESCRIPTION OF THE INVENTION

Condo Smart Cart System allows apartment or condo owners to securely store and conveniently locate carts in parking garages. This invention can be comprised of an upright, collapsible cart, constructed in the same way as traditional small, metal carts. Attached to the handle of the cart may be a chain with locking mechanism. With this product, two locking methods can be available. Residents may choose either a personalized key or a card, both of which can fit into a corresponding security device.

The embodiments of the invention in which an exclusive property or privilege is claimed are defined as follows:

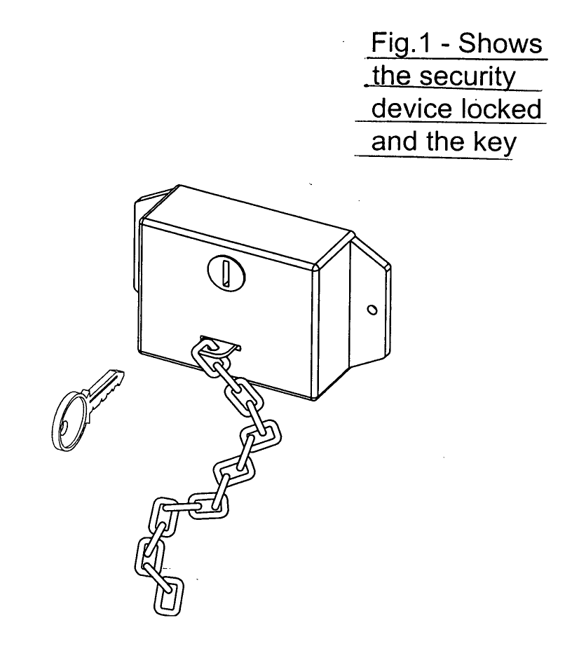

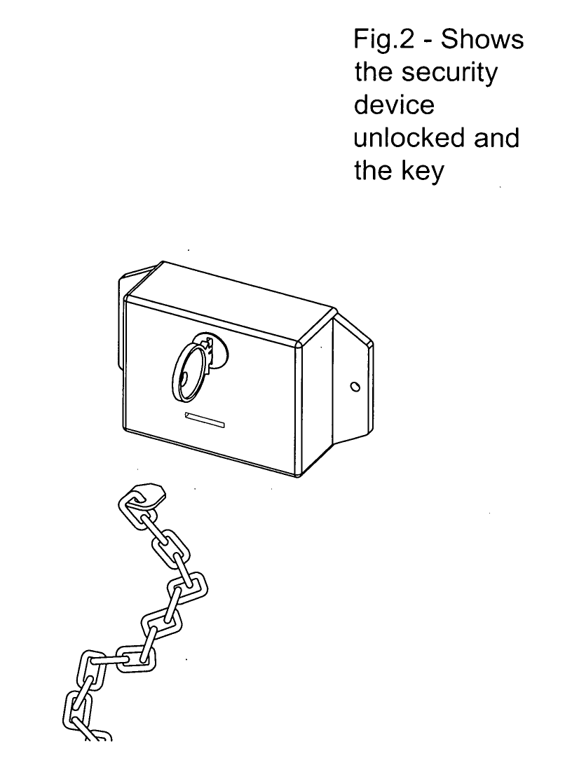

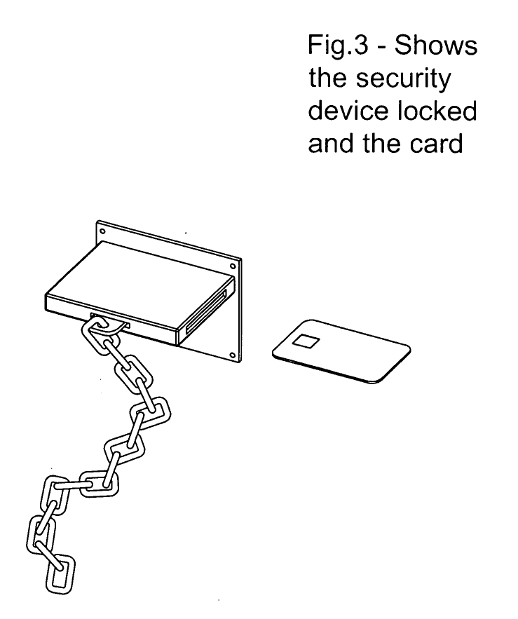

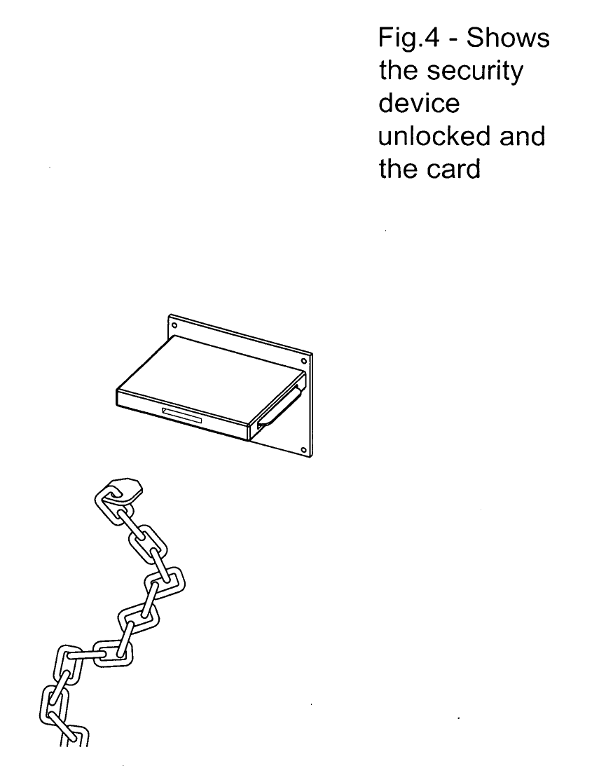

1. This invention can be comprised of an upright, collapsible cart, constructed in the same way as traditional small, metal carts. Attached to the handle of the cart may be a chain with locking mechanism which can be made of suitable metal material. Two locking methods can be available: personalized key, FIGS. 1 and 2 or a card, FIGS. 3 and 4, both of which can fit into a corresponding security device.

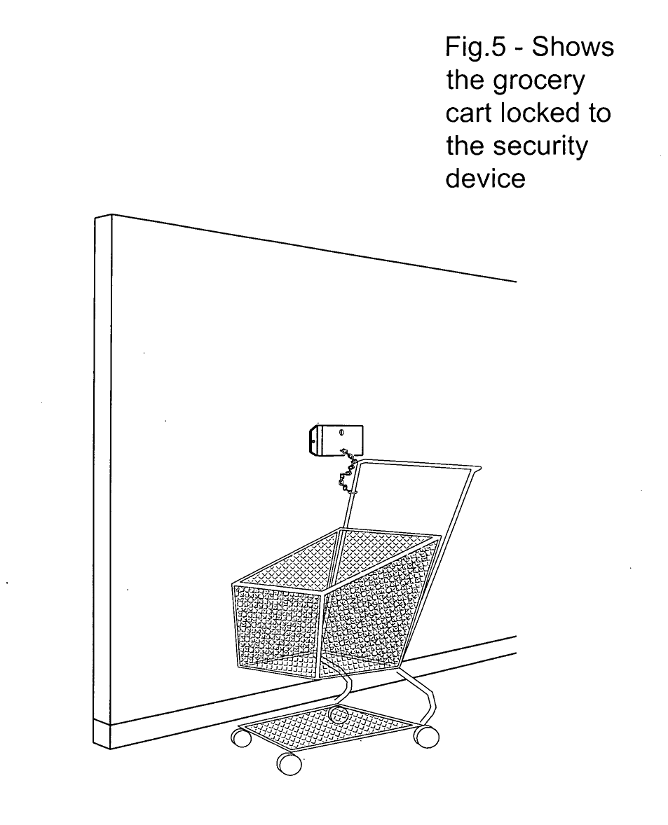

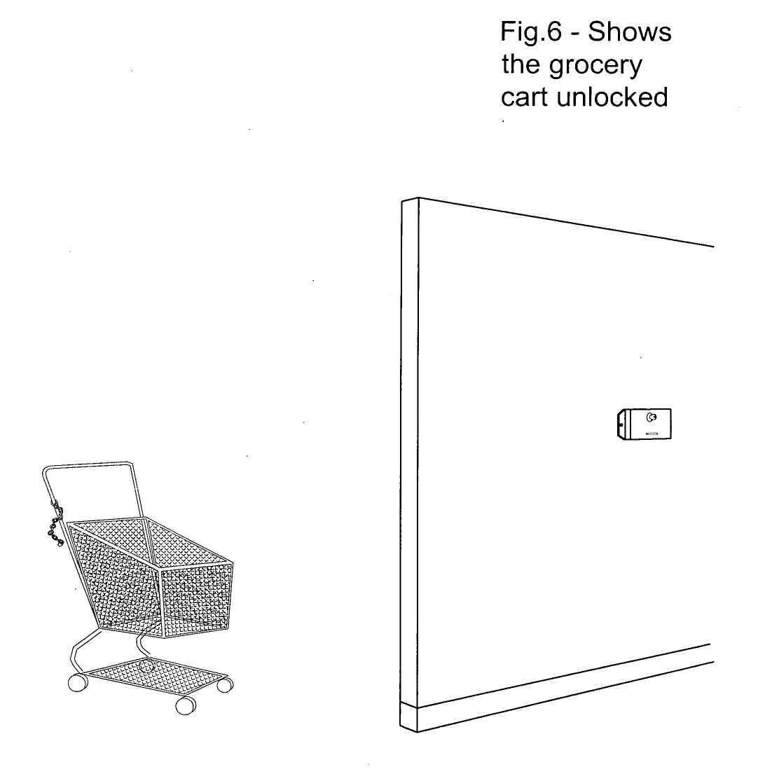

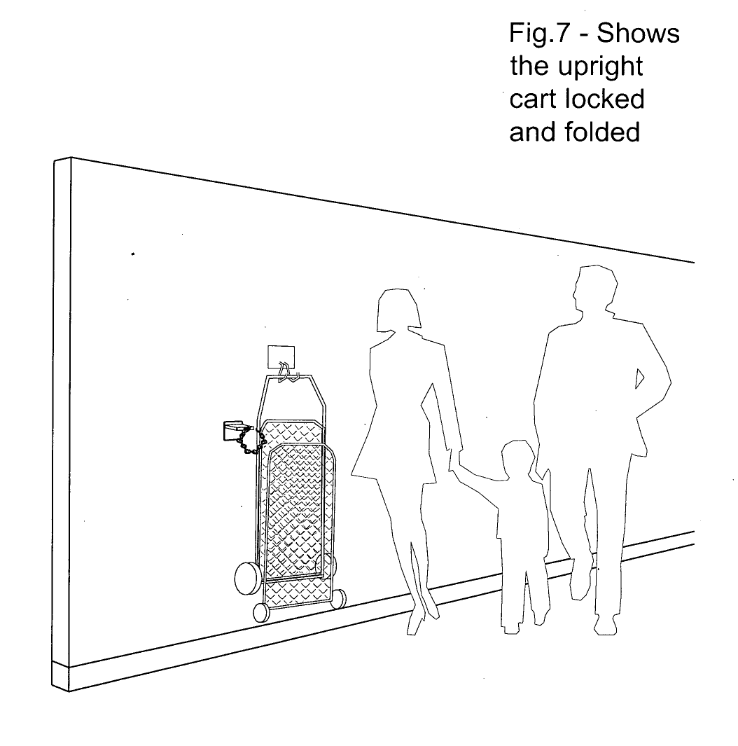

2. A system as defined in claim 1, the security device can be mounted to a wall and may include a keyhole and a card slot. To lock the cart using either the key or card method, residents may insert the key provided at the end of the chain into the security device (FIGS. 5 and 7). To unlock the cart, each condo or apartment resident will have his/her own personalized key or card, which can be inserted into the device. The key or card may remain inside the device with visible unit number until the cart has been returned to the garage or parking area and locked into the device. (FIG. 6)

3. A system as defined in claim 2, it may be available in a variety of colors to suit user preferences. The exact specifications may vary.
